(19) United States
(12) Patent Application Publication
(10) Pub. No.: US 2024/0217076 A1
(43) Pub. Date: Jul. 4, 2024

(54) Wrench Shaft Structure

(71) Applicant: KABO Tool Company, Taichung City (TW)

(72) Inventor: Chih-Ching Hsieh, Taichung City (TW)

(21) Appl. No.: 18/148,348

(22) Filed: Dec. 29, 2022

(51) Int. Cl. B25B 23/00

(52) U.S. Cl. CPC B25B 23/0028; B25B 23/0035

(57) ABSTRACT

A wrench shaft structure includes a working head, a shaft, and a through hole unit. The working head has a pivotal connection portion at one end. The pivotal connection portion has a through bore. The shaft has a lug portion at one end and a body portion. The lug portion has a connection hole pivotally connected to the through bore such that the working head is pivotally connected to the shaft. The through hole unit has a layout length along the body portion and penetrates the body portion in the same direction as that in which the connection hole penetrates the lug portion. While the through hole unit is configured to reduce the weight of the shaft, the body portion still has a continuous structure along the moment arm of the force applied to the shaft during operation so that the shaft can apply a force of the expected magnitude.

### BACKGROUND OF THE INVENTION

### 1. Technical Field

The present invention relates to a hand tool. More particularly, the invention relates to a wrench shaft structure that allows the weight of the wrench shaft to be reduced without affecting the magnitude of the force that can be applied to or by the wrench shaft during operation.

### 2. Description of Related Art

The conventional wrenches, in particular a hinge handle wrench 10 as shown in FIG. 1, have a handle portion 11 and a working head 12. The handle portion 11 is composed of a solid shaft and is provided with two lugs 111 at the front end. The front end of the working head 12 has a working portion 121, and the rear end of the working head 12 is a connecting end 122 pivotally provided between the two lugs 111 so that the working head 12 can be rotated with respect to the handle portion 11. A force can be applied to the working portion 121 through the handle portion 11 in order to rotate and thereby tighten or loosen a workpiece.

The handle portion 11 is configured as a solid shaft to withstand forces of relatively great magnitudes. The solid shaft configuration, however, results in a relatively great weight that a user has to hold or carry while operating or handling the wrench 10 and which therefore increases the difficulty of operation and use.

### BRIEF SUMMARY OF THE INVENTION

The primary objective of the present invention is to provide a wrench shaft structure that allows the weight of the wrench shaft to be reduced to lower the operational burden on a user but will not affect the magnitude of the force that can be applied to or by the wrench shaft during operation.

Another objective of the present invention is to provide a wrench shaft structure that has a through hole unit penetrating the wrench shaft in the same direction as the force application direction so that not only can the weight of the shaft be reduced, but also the shaft still has a complete structure along the moment arm of the force applied to the shaft during operation, meaning the weight of the wrench shaft can be reduced without affecting the magnitude of the force that can be applied to or by the wrench shaft during operation.

To achieve the aforesaid objectives, the present invention provides a wrench shaft structure that includes a working head, a shaft, and a through hole unit.

The working head has a working portion at one end and a pivotal connection portion at the opposite end. The working portion is configured to be coupled to a workpiece. The pivotal connection portion has a through bore.

The shaft has a lug portion at one end, a grip portion at the opposite end, and a body portion formed between the lug portion and the grip portion. The lug portion is provided with a connection hole. The connection hole and the through bore are aligned with each other and then connected by a pivotal connection element that passes through the connection hole and the through bore to connect the working head to the shaft pivotally. The body portion has a length along the axial direction of the shaft and a height along a radial direction of the shaft. The height direction is perpendicular to the axial direction of the connection hole of the lug portion.

The through hole unit has one or a plurality of through holes and penetrates the body portion of the shaft. The direction in which the through hole unit penetrates the body portion is the same as the direction in which the connection hole penetrates the lug portion. The through hole unit has a layout length along the longitudinal direction of the body portion.

The wrench shaft structure provided by the present invention is so designed that the at least one through hole in the body portion penetrates the shaft to reduce the weight of the shaft, and that the strength of the entire shaft is nevertheless preserved because the body portion still has a continuous structure along the moment arm of the force applied to the shaft during operation. Preferably, the layout length of the through hole unit ranges from one sixth to nine tenths of the length of the body portion.

Preferably, the layout length of the through hole unit is greater than one half of the length of the body portion.

Preferably, the layout length of the through hole unit is greater than the length of the grip portion.

The through hole unit may be formed by one or at least two elongated through holes, and in the latter case, the at least two elongated through holes are arranged at intervals along the body portion.

The through hole unit may also be formed by a plurality of through holes that are arranged at intervals along the body portion.

The through holes may have the same size or different sizes and may be arranged at equal intervals or unequal intervals.

### BRIEF DESCRIPTION OF THE SEVERAL VIEWS OF THE DRAWINGS

To enable a better understanding of the objectives, features, and intended effects of the present invention, six preferred embodiments of the present invention are described in detail below with reference to the accompanying drawings, in which:

FIG. 1 is a perspective view of a conventional wrench;

FIG. 2 is a perspective view of the first preferred embodiment of the invention;

FIG. 3 is an exploded perspective view of the first preferred embodiment of the invention;

FIG. 4 is a side view of the first preferred embodiment of the invention, showing the proportion and location of the elongated through hole;

FIG. 5 is a cross-sectional view taken along line 5-5 in FIG. 3, showing the structure of the body portion in the force application direction;

FIG. 6 is a top view of the first preferred embodiment of the invention, showing that the axis of the connection holes of the shaft and the penetration direction of the through hole unit are parallel to the force application direction of the wrench;

FIG. 7 is a side view of the second preferred embodiment of the invention, showing the circular through holes and their locations;

FIG. 8 is a side view of the third preferred embodiment of the invention, showing the locations and diameter variation of the circular through holes;

FIG. 9 is a side view of the fourth preferred embodiment of the invention, showing the locations and spacing variation of the circular through holes;

FIG. 10 is a side view of the fifth preferred embodiment of the invention, showing the locations of the elongated through holes; and

FIG. 11 is a side view of the sixth preferred embodiment of the invention, showing the locations of the elongated through holes.

### DETAILED DESCRIPTION OF THE INVENTION

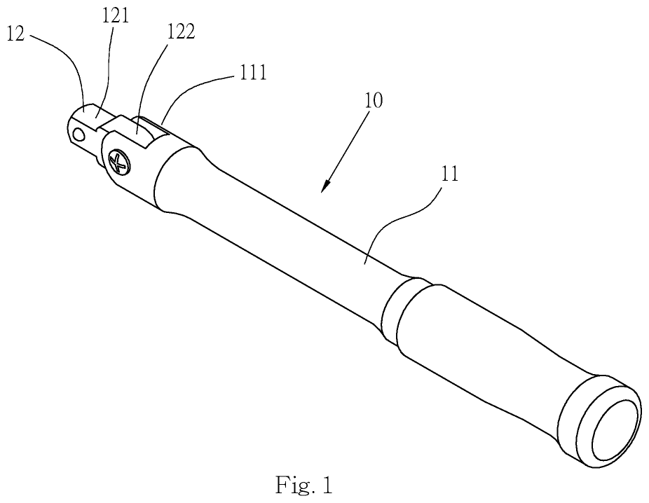

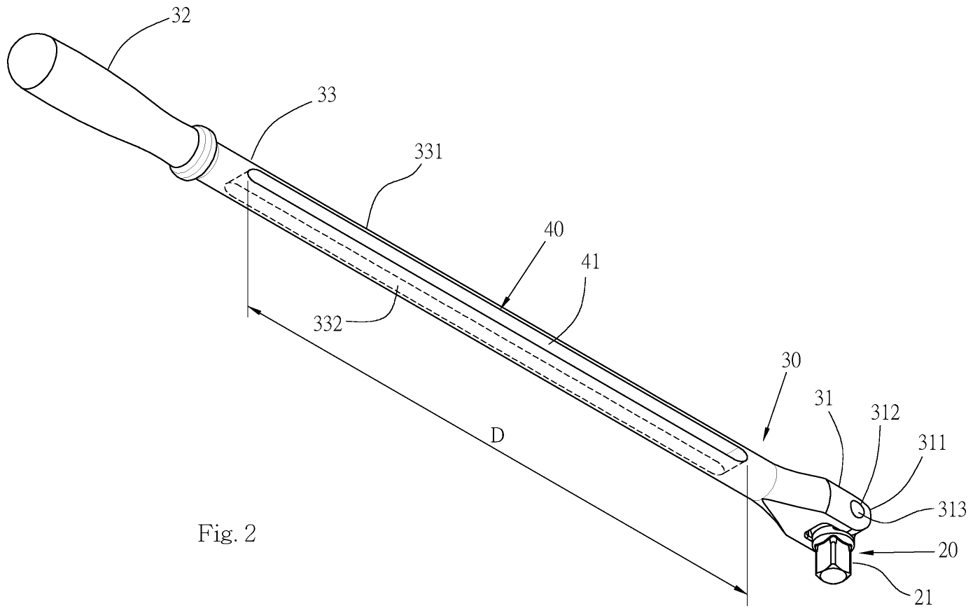

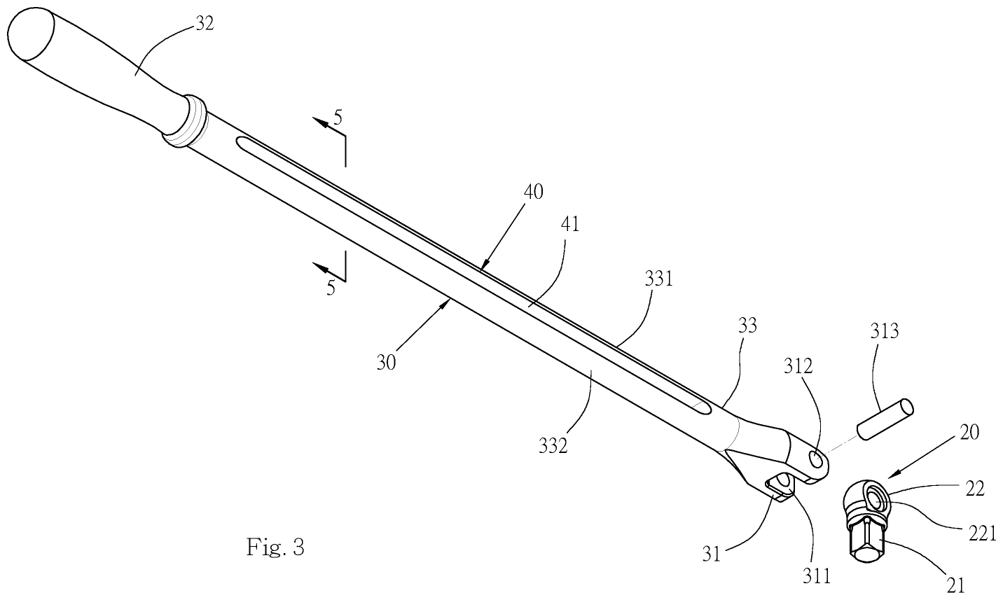

Please refer to FIG. 1 to FIG. 6 for the wrench shaft structure according to the first preferred embodiment of the present invention. The wrench shaft structure, or wrench, includes a working head 20, a shaft 30, and a through hole unit 40.

The working head 20 has a working portion 21 at the front end and a pivotal connection portion 22 at the rear end. The working portion 21 in this embodiment is a hexagonal prism projecting vertically from the working head 20. The working portion 21 is configured to be inserted into and thereby connected to a socket (not shown) or workpiece (not shown) so that by rotating the working portion 21, the socket or workpiece can be driven, and thus tightened or loosened in a threaded manner, by the working portion 21. The pivotal connection portion 22 has a through bore 221. The axial direction of the through bore 221 is perpendicular to the axial direction of the working portion 21.

The shaft 30 is a solid shaft with a circular cross section. The shaft 30 is provided with a lug portion 31 at one end, a grip portion 32 at the other end, and a body portion 33 defined between the grip portion 32 and the lug portion 31. The lug portion 31 is composed of two lugs 311. Each of the two lugs 311 is provided with a connection hole 312. The pivotal connection portion 22 is provided between the two lugs 311, with the through bore 221 aligned with the connection holes 312, and a pivotal connection element 313 extending through and connecting the through bore 221 and the connection holes 312 such that the working head 20 is pivotally connected to the shaft 30 and can be rotated within a predetermined angular range about an axis defined by the pivotal connection element 313. To operate the wrench, a user holds the grip portion 32 of the shaft 30 and applies a force to the grip portion 32 in the axial direction of the connection holes 312 (or in either of the two opposite axial directions of the connection holes 312, to be exact) so as to rotate the shaft 30 about an axis defined by the working portion 21 of the working head 20. Referring to FIG. 6, the structure of the present invention is such that when a socket (not shown) coupled to the working portion 21 is rotated by pushing the wrench in the direction F, the axial direction X of the connection holes 312 of the lug portion 31 is parallel to the force application direction F, i.e., the direction in which the pushing force is applied to the grip portion 32 of the shaft 30. The body portion 33 has a length L between the lug portion 31 and the grip portion 32, and the length L is multiple times the length of the grip portion 32. Preferably, the length L of the body portion 33 is two to ten times the length of the grip portion 32. More preferably, the length L of the body portion 33 is three to six times the length of the grip portion 32. In addition, the body portion 33 has a top side defining a top surface 331, a bottom side defining a bottom surface 332, and a thickness H between the top surface 331 and the bottom surface 332.

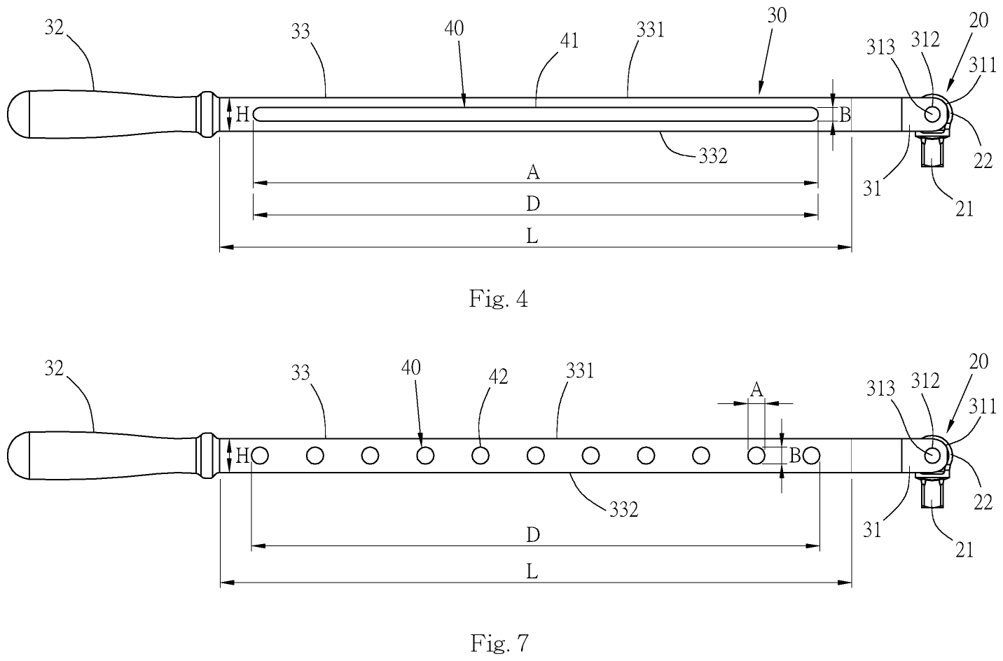

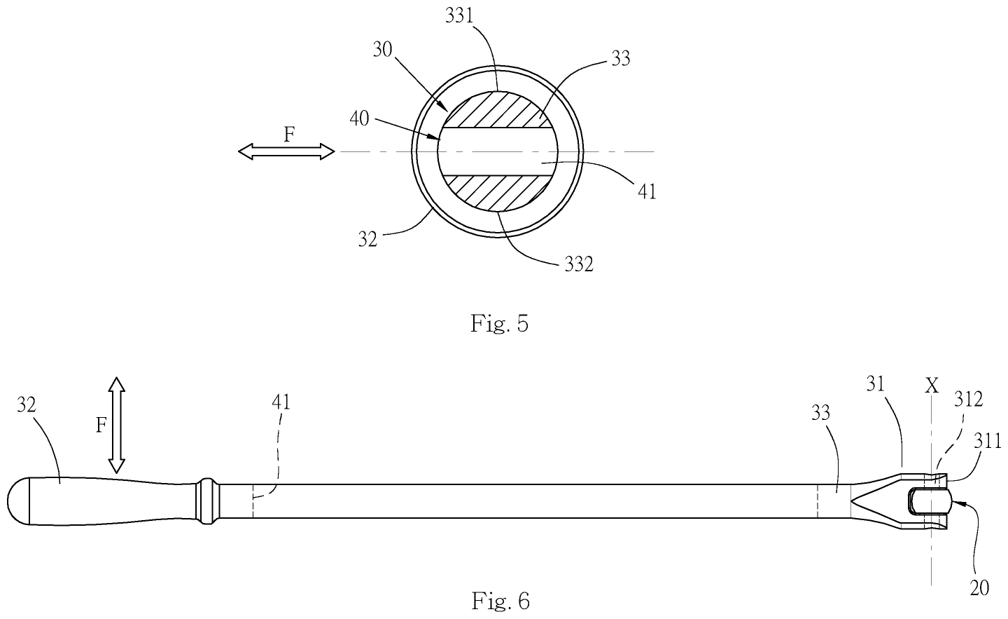

Referring to FIG. 4, FIG. 5, and FIG. 6, the through hole unit 40 penetrates the body portion 33 and may be formed by a single through hole or a plurality of through holes. The direction in which the through hole unit 40 penetrates the body portion 33 (also referred to herein as the penetration direction) is the same as the direction in which the connection holes 312 penetrate the lug portion 31. In other words, the penetration direction of the through hole unit 40 is parallel to the axial direction X of the connection holes 312 and the force application direction F of the grip portion 32. That is to say, the penetration direction of the through hole unit 40 is the same as the force application direction F of the shaft 30. The body portion 33, therefore, maintains a continuous structure along the moment arm of the force applied in the direction F by a user holding the grip portion 32 during operation. More specifically, the continuous structure is located between the top surface 331 or the bottom surface 332 and the through hole unit 40 to ensure that the through hole unit 40 will not lower the magnitude of the force that the shaft 30 can withstand. Thus, the through hole unit 40 can reduce the weight of the shaft 30 and hence the operational burden on a user without affecting the magnitude of the force that can be applied to or by the shaft 30 during operation. The through hole unit 40 in this embodiment is a single elongated through hole 41 with two circular ends; the through hole unit 40, however, is not limited to this configuration. The elongated through hole 41 has a hole length A along the length direction of the body portion 33 and a hole height B along the thickness direction of the body portion 33. The ratio of the hole length A of the elongated through hole 41 to the length L of the body portion 33 is 0.5-0.9 and is 0.8 in this embodiment. The ratio of the hole height B of the elongated through hole 41 to the thickness H of the body portion 33 is 0.6-0.9 and is 0.8 in this embodiment. The elongated through hole 41 further defines a layout length D along the body portion 33. In this embodiment, the layout length D is the hole length A of the through hole 41. In practice, the layout length D of the through hole unit 40 may range from one sixth to nine tenths of the length L of the body portion 33. Preferably, the layout length D is greater than one half of the length L of the body portion 33, and the layout length D is greater than the length of the grip portion 32.

To use, the working portion 21 of the working head 20 is coupled to a workpiece (not shown), and after adjusting the angle between the working head 20 and the shaft 30 as needed, the user applies a force to the terminal end (i.e., the grip portion 32) of the shaft 30 and rotates the shaft 30 about the axis defined by the working portion 21 of the working head 20 such that a torque whose magnitude is the product of the force applied to the shaft 30 and the length of the shaft 30 is generated to tighten or loosen the workpiece in a threaded manner. While the shaft 30 is being rotated, referring to FIG. 6, the continuous structure of the body portion 33 that extends along the moment arm of the force applied in the direction F and is located between the top surface 331 of the body portion 33 and the through hole unit 40 and between the bottom surface 332 and the through hole unit 40 ensures that the magnitude of the force that the shaft 30 can withstand will not be affected. In the meantime, the through hole unit 40 reduces the weight of the shaft 30 by extending through, and thus reducing certain volume of, the body portion 33. The provision of the through hole unit 40, therefore, prevents the shaft 30 from weighing too much on the hand of the user holding it and thereby lowers the operational burden on the user.

Please refer to FIG. 7 for the second preferred embodiment of the present invention. The main structure of this embodiment is the same as that of the previous embodiment, and identical structural features in the two embodiments are denoted by the same reference numerals and will not be described repeatedly.

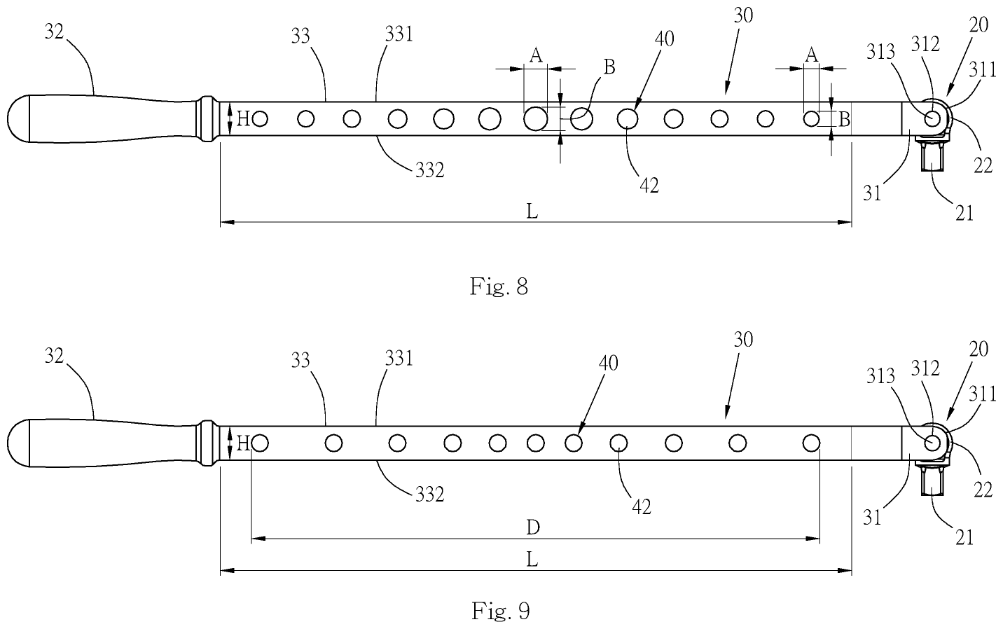

The through hole unit 40 in the second preferred embodiment is composed of a plurality of circular through holes 42. Each circular through hole 42 has a hole length A and a hole height B that are equal to each other. The circular through holes 42 are of the same size and are arranged along the body portion 33 at equal intervals. The ratio of the sum of the hole lengths A of the circular through holes 42 to the length L of the body portion 33 is 0.6. The ratio of the hole height B of each circular through hole 42 to the thickness H is 0.7. Moreover, the through holes 42 of the through hole unit 40, which are distributed along the shaft 30 at equal intervals, define a layout length D. As in the previous embodiment, the layout length D of the through hole unit 40 ranges from one sixth to nine tenths of the length L of the body portion 33, is preferably greater than one half of the length L of the body portion 33, and is preferably greater than the length of the grip portion 32. The part of the body portion 33 that is not penetrated by the circular through holes 42 forms a vertically continuous reinforcement structure that can prevent the shaft 30 from deformation by pressure applied to the upper and/or lower side of the shaft 30. In addition, referring to FIG. 8 and FIG. 9, which show the third and the fourth preferred embodiments of the present invention respectively, the circular through holes 42 may be located along the body portion 33 in a different way from that shown in FIG. 7 (e.g., at different intervals) or vary in hole diameter. As shown in FIG. 8, the circular through hole 42 at the lengthwise center of the shaft 30 has the greatest hole length A (hole height B), whereas the remaining circular through holes 42 have gradually decreased hole lengths A (hole heights B) as they get closer to the front or rear end of the body portion 33 (i.e., to the lug portion 31 or the grip portion 32). In FIG. 9, the spacing between the circular through holes 42 has been changed such that the intervals at which the circular through holes 42 are arranged are increased toward the front and rear ends of the body portion 33 (i.e., toward the lug portion 31 and the grip portion 32). Depending on design requirements, the intervals may be gradually increased, and/or the hole diameters gradually reduced, toward the lengthwise center of the body portion 33 instead. In the third and the fourth preferred embodiments, the ratios between the layout length D of each through hole unit 40 and the lengths of the corresponding body portion 33 and grip portion 32 are the same as those stated above.

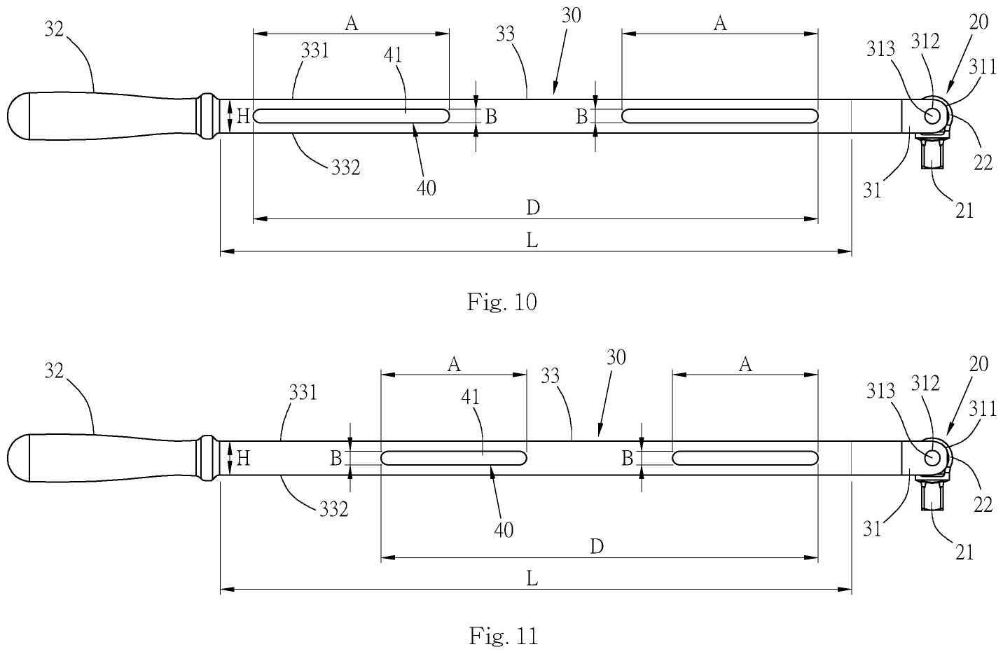

Please refer to FIG. 10 for the fifth preferred embodiment of the present invention. The main structure of this embodiment is the same as that of the first preferred embodiment, and identical structural features in the two embodiments are denoted by the same reference numerals and will not be described repeatedly.

The through hole unit 40 in the fifth preferred embodiment includes two elongated through holes 41 provided in the body portion 33. The two elongated through holes 41 are adjacent to the front and rear ends of the body portion 33 (i.e., adjacent to the lug portion 31 and the grip portion 32) respectively such that a relatively long interval between the two elongated through holes 41 exists at the lengthwise center of the body portion 33. In the sixth preferred embodiment of the present invention as shown in FIG. 11, the through hole unit 40 also includes two elongated through holes 41, but the two elongated through holes 41 are arranged at equal intervals with respect to each other and the grip portion 32. In each of the embodiments shown in FIG. 10 and FIG. 11, the two through holes 41 distributed at intervals along the shaft 30 also define a layout length D along the body portion 33.

The wrench shaft structure provided by the present invention uses the through hole unit to reduce the weight of the shaft. Thanks to the through hole unit, therefore, the shaft of the invention weighs less than the conventional wrenches (whose handle portions are solid structures) and can lower the operational burden on a user. The overall strength of the shaft, however, is unaffected because the body portion still has a continuous structure along the moment arm of the force applied to the shaft during operation; in other words, the continuous structure allows the magnitude of the force that can be applied to or by the shaft during operation to be unaffected by the through hole unit.

The embodiments disclosed herein serve only to expound, but not to limit, the technical means of the present invention. All equivalent modifications made to the disclosed embodiments shall be viewed as falling within the scope of the invention. The wrench shaft structure of the invention is the first of its kind in the art and provides a utilitarian advantage over the prior art, and in view of this, a patent application for the invention is hereby filed according to the law.

What is claimed is:

1. A wrench shaft structure, comprising:
a working head having an end with a working portion and an opposite end with a pivotal connection portion, wherein the working portion is configured to be coupled to a workpiece, and the pivotal connection portion has a through bore;
a shaft having an end provided with a lug portion, an opposite end provided with a grip portion, and a body portion defined between the lug portion and the grip portion, wherein the lug portion is provided with a connection hole, the connection hole penetrates the lug portion along a direction defined as an axial direction of the connection hole, the connection hole and the through bore of the working head are aligned with each other and are penetrated and connected by a pivotal connection element such that the working head is pivotally connected to the shaft, the body portion has a length between the lug portion and the grip portion, the body portion further has a top surface, a bottom surface, and a thickness between the top surface and the bottom surface, and the thickness is defined in a direction perpendicular to the axial direction of the connection hole of the lug portion; and
a through hole unit having at least one through hole and penetrating the body portion of the shaft, wherein the through hole unit penetrates the body portion in a same direction as the axial direction of the connection hole of the lug portion and has a layout length along a longitudinal direction of the body portion.

2. The wrench shaft structure of claim 1, wherein the layout length of the through hole unit ranges from one sixth to nine tenths of the length of the body portion.

3. The wrench shaft structure of claim 1, wherein the layout length of the through hole unit is greater than one half of the length of the body portion.

4. The wrench shaft structure of claim 1, wherein the layout length of the through hole unit is greater than a length of the grip portion.

5. The wrench shaft structure of claim 1, wherein the at least one through hole of the through hole unit is at least one elongated through hole having a hole length along a direction of the length of the body portion and a hole height along the direction of the thickness of the body portion, and the hole length is greater than the hole height.

6. The wrench shaft structure of claim 1, wherein the at least one through hole of the through hole unit is at least two elongated through holes.

7. The wrench shaft structure of claim 1, wherein the at least one through hole of the through hole unit is a plurality of circular through holes, each said circular through hole has a hole length along a direction of the length of the body portion and a hole height along the direction of the thickness of the body portion, and the hole length of each said circular through hole is equal to the hole height thereof.

8. The wrench shaft structure of claim 7, wherein the circular through holes have the same hole length, and the circular through holes are arranged at equal intervals.

9. The wrench shaft structure of claim 7, wherein the circular through holes have different said hole lengths, and the circular through holes are arranged at equal intervals.

10. The wrench shaft structure of claim 7, wherein the circular through holes have the same hole length, and the circular through holes are arranged at unequal intervals.

11. The wrench shaft structure of claim 1 wherein a total hole length of the through hole unit and the length of the body portion are in a ratio of 0.5-0.9.

12. The wrench shaft structure of claim 1, wherein a hole height/the hole height of the at least one through hole of the through hole unit and the thickness of the body portion are in a ratio of 0.6-0.9.

13. The wrench shaft structure of claim 1, wherein the length of the body portion is multiple times a length/the length of the grip portion.

14. The wrench shaft structure of claim 1, wherein the grip portion of the shaft has a force application direction, and the force application direction is parallel to the axial direction of the connection hole of the lug portion and is parallel to the direction in which the through hole unit penetrates the body portion.
